(19) United States
(12) Patent Application Publication
(10) Pub. No.: US 2008/0194249 A1
(43) Pub. Date: Aug. 14, 2008

(54) Mobile Communication System and Method Thereof For Service Redirection Between Asynchronous Network and Synchronous Network

(76) Inventor: Young-Lak Kim, Seoul (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/579,498

(22) PCT Filed: May 3, 2005
(86) PCT No.: PCT/KR2005/001286

§ 371 Date: Dec. 20, 2007

(30) Foreign Application Priority Data
May 6, 2004 (KR) 10-2004-0031630

(51) Int. Cl. H04Q 7/20

(52) U.S. Cl. 455/424

(57) ABSTRACT

The present invention relates to a mobile communication service system and a method thereof for redirecting services between an asynchronous network and a synchronous network, performing the redirection of the services from a mobile communication service system based on the asynchronous network to a mobile communication service system based on the synchronous network. While detecting the mobile communication service system based on the asynchronous network, if an error is generated in the system, by redirecting the mobile communication service system based on the asynchronous network and broadcasting a network redirection message, which requests to all of mobile communication terminals to which the services are being provided, the redirection of the services to the mobile communication service system based on the synchronous network through the mobile communication service system based on the asynchronous network, the mobile communication terminal can be provided with the services by the mobile communication service system based on the synchronous network, thereby providing the higher quality of mobile communication services.

### TECHNICAL FIELD

The present invention relates to a mobile communication service system and a method thereof, particularly to a mobile communication system and a method thereof for service redirection between an asynchronous network and a synchronous network, wherein a service redirection can be made from a mobile communication system based on an asynchronous network to a mobile communication system based on a synchronous network.

### BACKGROUND ART

A mobile communication service was provided for the first time in late 1980's as a low quality voice call provided by an analogue cellular type AMPS (Advanced Mobile Phone Service), which is called the first generation mobile communication service.

The second generation mobile communication service enabled an advanced voice call and a low speed (14.4 Kbps) data transmission by the development of GSM (Global System for Mobile), CDMA (Code Division Multiple Access), TDMA (Time Division Multiple Access), etc.

Subsequently, the 2.5 generation mobile communication service developed a more advanced voice call and a low speed but advanced (144 Kbps) data transmission possible with the development of a worldwide usable PCS (Personal Communication Service) which could be accomplished by the securing of GHz band frequency. For a mobile communication network used for the 1^{st} to 2.5 generation mobile communication services, a user's terminal, a base station transmitter, a base station controller, a mobile switching station, a home location register (HLR), a visitor location register (VLR), etc. were built into it.

The 3^{rd} generation mobile communication service is provided by two systems, i.e., the asynchronous network based WCDMA system suggested by the 3GPP (Generation Partnership Project) and the synchronous network based CDMA-2000 system suggested by the 3GPP2.

As illustrated so far, various mobile communication service systems have been developed along with the advancing mobile communication technology and networks. Recently, in order to resolve the problem of global roaming between mobile communication service systems, which are adopted differently by countries, a multi-mode multi-band mobile communication terminal (hereinafter “MM-MB terminal”, which is used for both asynchronous network based mobile communication service systems and synchronous network based mobile communication service systems, is being developed.

Such an MM-MB terminal has the problem that in an area where the asynchronous network based mobile communication service system is mixed with the synchronous network based mobile communication service system, if the synchronous network based mobile communication service system is stable or if the asynchronous network based mobile communication service system has an disorder in network, the conversion of the synchronous network based mobile communication service system is necessary as occasion demands.

### DISCLOSURE OF INVENTION

### Technical Problem

The present invention is provided to overcome the foregoing stated problem which the prior art contains. It is the object of the present invention to provide a mobile communication service system and a method thereof for redirecting services between an asynchronous network and a synchronous network, performing the redirection of the services from the asynchronous network based mobile communication service system to the synchronous network based mobile communication service system, if an error occurs in the asynchronous network based mobile communication service system or if the synchronous communication service system is more stable.

### Technical Solution

In order to achieve the above object, a preferred embodiment of the present invention provides a mobile communication service system for redirecting services between an asynchronous network and a synchronous network comprising: an asynchronous network based mobile communication service system; a synchronous network based mobile communication service system; and a mobile terminal wireless-connection to the asynchronous network based mobile communication service system and the synchronous network based mobile communication service system and being provided with a service adequate to the quality and environment of each network, wherein the asynchronous network based mobile communication service system includes an EMS (Element Management System) monitoring the asynchronous network based mobile communication service system and, if an error occurs in the system, broadcasting a network redirection message, which requests for the redirection of services to the synchronous network based mobile communication service system, to all of the mobile terminals, which are being connected to and served by the asynchronous network based mobile communication service system, through the asynchronous network based mobile communication service system.

Also, a preferred embodiment of the present invention provides a mobile communication service method for redirecting services between an asynchronous network and a synchronous network comprising: (a) if an error occurs in an asynchronous network based mobile communication service system, a step of an EMS requesting all of MM-MB terminals, which are receiving services from the asynchronous network based mobile communication service system, to redirect their modes to the synchronous network based mobile communication service system; and (b) a step of the MM-MB terminals performing a network redirection from the asynchronous network based mobile communication service system to the synchronous network based mobile communication service system.

### Advantageous Effects

By providing such mobile communication service system and a method thereof for the redirection of services from an asynchronous network to a synchronous network, when an error occurs in an asynchronous network based mobile communication service system, all of the mobile communication terminals, which are set as a voice call or a packet call under the asynchronous network based mobile communication service system, redirect their services to a synchronous network based mobile communication service system. Therefore, a higher quality mobile communication service can be provided to the subscribers.

### BRIEF DESCRIPTION OF THE DRAWINGS

FIG. 1 is a diagram showing the configuration of a mobile communication service system according to the preferred embodiment of the present invention.

FIG. 2 is a diagram showing the configuration of an MM-MB terminal according to the preferred embodiment of the present invention.

FIG. 3 is a flow chart showing a mobile communication service method for the redirection of a service from an asynchronous network to a synchronous network according to the preferred embodiment of the present invention.

FIG. 4 is another flow chart showing a mobile communication service method for the redirection of a service from an asynchronous network to a synchronous network according to the preferred embodiment of the present invention.

### BEST MODE FOR CARRYING OUT THE INVENTION

Hereunder, with reference to the attached drawings, a preferred embodiment of the present invention is detailedly explained.

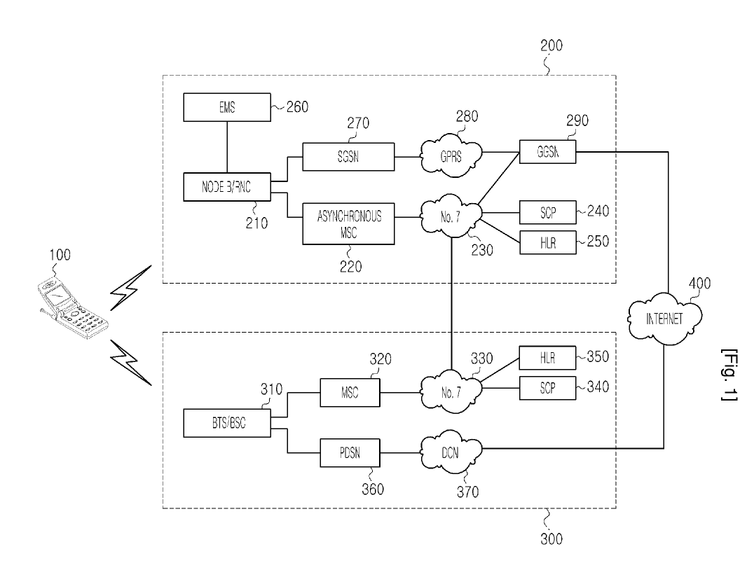

FIG. 1 is a diagram showing the configuration of a mobile communication service system according to the preferred embodiment of the present invention.

As illustrated in FIG. 1, the system comprises: an asynchronous network based mobile communication service system (hereunder “asynchronous mobile communication system”) 200; a synchronous network based mobile communication service system (hereunder “synchronous mobile communication system”); and a multi-mode multi-band mobile communication terminal (hereunder “MM-MB terminal”) 100 wireless-connecting to the asynchronous mobile communication system 200 or the synchronous mobile communication system and receiving a voice or data service.

The asynchronous mobile communication system 200 comprises: a node B as a base station for the communication in a wireless area with the MM-MB terminal 100 and node B/a ratio network controller (hereunder “RNC”) 210 for controlling the node B; an elementary management system (hereunder “EMS”) 260 connected to the node B and the RNC 210 and performing such functions as storing the configuration and information of the system, sensing an error of the system, changing a setting of the system, and monitoring the status of the system; an asynchronous MSC 220 connected with the RNC 210 and performing a call exchange to provide the MM-MB terminal 100 with a voice or data service; a service control point (hereunder “SCP”) 240 connected with the asynchronous MSC 220 through a No. 7 common signal network 230 and managing the network resources and services; a serving GPRS support node (hereunder “SGSN”) 270 connected between the RNC 210 and the GPRS 280 and performing the maintenance of the location track of the MM-MB terminal 100, the control of access, and the security function; and a gateway support node (hereunder “GGSN”) 290 connected through the SGSN 270 and a general packet radio service (hereunder “GPRS”) 280, and supporting the communication with an outside packet with the connection with the Internet. A WCDMA system can be an example of the asynchronous mobile communication system 200.

The synchronous mobile communication system 300 comprises: a base transceiver station (hereunder “BTS”)/a base station controller (hereunder “BSC”) 310; an MSC 320 connected with at least one BSC 310 and performing the exchange of calls; a service control point (hereunder “SCP”) 340 connected with the MSC 320 through a No. 7 common signal network 330; a packet data service node (hereunder “PDSN”) 360 connected with the SCP 340 and the BSC 310 and providing a subscriber with a packet data service; and a data core network (hereunder “DCN”) 370 supporting the connection between the PDSN 360 and an outside network 400 (e.g., Internet). A CDMA2000 system can be an example of the synchronous mobile communication system 300.

Meanwhile, the MSC 220 of the asynchronous mobile communication system 200 and the MSC 320 of the synchronous mobile communication system 300 are inter-connected through the No. 7 common signal networks 230, 330, to transmit and receive information required for a handover, etc. of the MM-MB terminal 100. Also, the HLR 250, 350 connected to the No. 7 common signal network 230, 330 stores and manages the information of a subscriber and the subscriber's status of using an additional service and provides the subscriber's information upon request of the MSC 220, 320.

Herein, the EMS 260 provides a service provider and an interface, and if an error occurs in the asynchronous mobile communication system 200, the EMS 260 broadcasts a service redirection request message so that all of the MM-MB terminals 100, which exist in the service area of the asynchronous mobile communication system 200, can make a service redirection to a synchronous mobile communication system 300.

The MM-MB terminal 100 is inter-changeable between a synchronous mode providing a synchronous network based mobile communication service and an asynchronous mode providing an asynchronous network based mobile communication service. Also, it can handle multi band such as 800 MHz (the 2^{nd} generation), 1.8 GHz (the 2.5 generation), and 2 GHz (the 3^{rd} and 4^{th} generations). The MM-MB terminal 100 is illustrated with reference to the attached drawings.

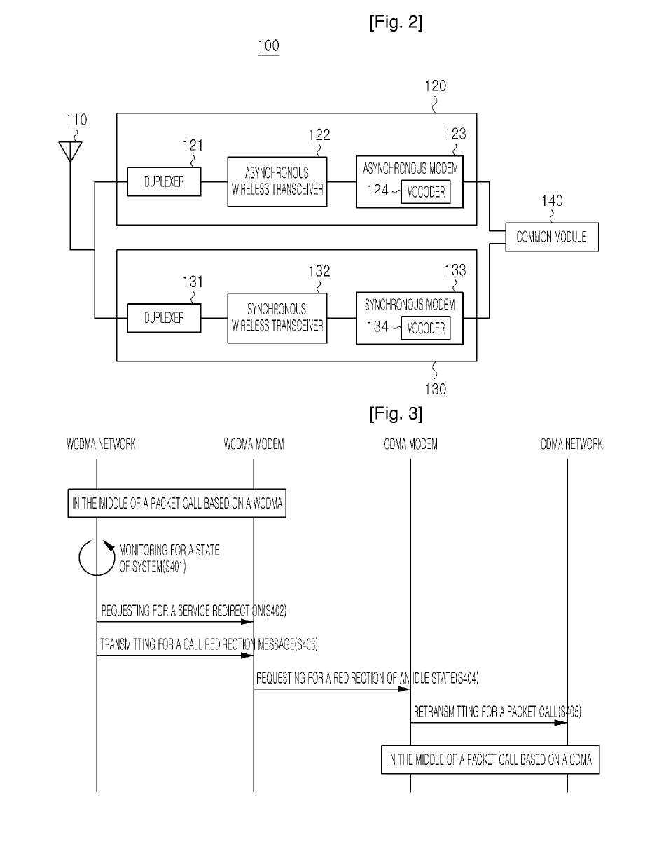

FIG. 2 is a diagram showing the configuration of the MM-MB- terminal according to the preferred embodiment of the present invention.

As shown in FIG. 2, the MM-MB terminal 100 includes an antenna 110, an asynchronous module 120, a synchronous module 130, and a common module 140.

The antenna 110 receives an RF signal transmitted from surrounding BTS 310, and transmits and receives an RF signal for a synchronous network based mobile communication service and an asynchronous network based mobile communication service.

The asynchronous module 120 includes: a duplexer 121 separating and band-passing the received multi-band frequency according to each band; an asynchronous wireless transceiver 122 separating the received multi-band frequency into a pre-determined frequency band; an asynchronous modem 123 processing the protocol in a wireless section with the asynchronous mobile communication system 200; and a vocoder 124 performing an encryption or decryption of a voice signal.

The synchronous module 130 includes: a duplexer 131 separating and band-passing the received multi-band frequency according to each band; a synchronous wireless transceiver 132 separating the received multi-band frequency into a predetermined frequency band; a synchronous modem 133 processing the protocol in a wireless section with the synchronous mobile communication system 300; and a vocoder 134 performing an encryption or decryption of a voice signal.

The common module 140 operates as a central processing unit for controlling the asynchronous modem 123 and the synchronous modem 133, and includes an application processor (not shown) processing a multimedia data, a memory (not shown), and an input/output (not shown).

The MM-MB terminal 100 configured as above described is mounted with a software for a user interface, an additional service, a mobility management, a connection/session control, a resource control, and a protocol processing so that a user can use various application services. Also, it performs a proper handover according to the environment of a communication network and converts the protocol according to the corresponding communication network environment to provide the optimum mobile communication service to the user.

In order to utilize a proper mobile communication network, if the EMS 260 broadcasts a network redirection message through the asynchronous mobile communication system 200, all of the MM-MB terminals 100 connected to the asynchronous mobile communication system 200 are re-connected to the synchronous mobile communication system 300. At this time, the MM-MB terminals 100 can be divided into those connected with the asynchronous mobile communication system 200 for a voice call and those connected for a packet call.

First, when the MM-MB terminal 100 is connected to the asynchronous mobile communication system 200 for a voice call, if the MM-MB terminal 100 receives the network redirection message, a series of network redirection process is performed according to the message. That is, in the case of a voice call connection, the network redirection is made through a handover message.

Secondly, when the MM-MB terminal 100 is connected to the asynchronous mobile communication system 200 for a packet call, if the MM-MB terminal 100 receives the network redirection message, a series of network redirection process is performed according to the message. That is, in the case of a packet call connection, the mobile communication service mode is converted by the function of a service redirection.

The service redirection message includes a frequency information, which is required for the MM-MB terminal 100 to redirect a packet call to the synchronous mobile communication system 300, and a PN code information of the BTS 310 for performing an handover.

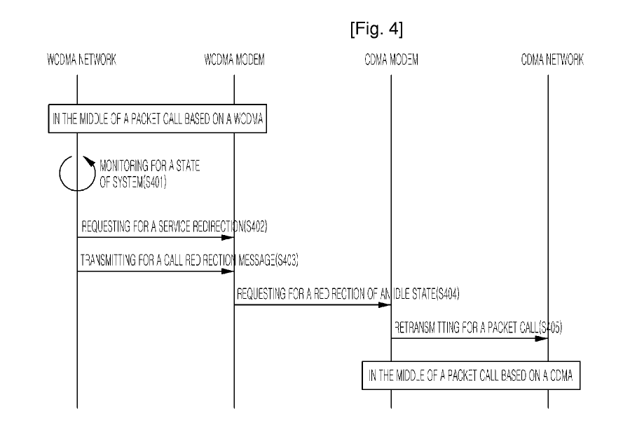

Such constructed present invention performs a service redirection from an asynchronous network to a synchronous network in the following method. The method is illustrated with reference to FIGS. 3 AND 4.

FIG. 3 is a flow chart showing a mobile communication service method for the redirection of a service from an asynchronous network to a synchronous network according to the preferred embodiment of the present invention. Herein, when the asynchronous mobile communication system 200 is connected to the MM-MB terminal 100 for a voice call, a service redirection method to a synchronous mobile communication system 300 is explained.

First, if the asynchronous mobile communication system 200 is in the middle of a voice call with the MM-MB terminal 100, the EMS 260 monitors whether there is an error in the asynchronous mobile communication system 200 [S301].

As a result of S301, if the EMS 260 senses an error from the asynchronous mobile communication system 200, the EMS 260 requests the asynchronous mobile communication system 200 to broadcast a call redirection request message to all of the MM-MB terminals 100 set for a voice call in the asynchronous mobile communication system 200 [S302]. Herein, the call redirection message represents a handover message for redirecting a mobile communication service mode.

Subsequently, if the MM-MB terminal 100 set for a voice call in the asynchronous mobile communication system 200 receives the call redirection message, the common module 140 of the MM-MB terminal 100 requests for a transition of a traffic state from the asynchronous modem 123 to a synchronous modem 133 [S303-S304].

Accordingly, the synchronous modem 133 performs the initialization for the traffic state transition, performs a handover process such as transmitting a reverse traffic to adjust the synchronicity to correspond to the synchronous mobile communication system 300, and transmits a handover completion message to the base station of the synchronous mobile communication system 300 [S305].

Thereafter, the MM-MB terminal 100 and the synchronous mobile communication system 300 transmit and receive a voice data and maintain a call state.

FIG. 4 is another flow chart showing a mobile communication service method for the redirection of a service from an asynchronous network to a synchronous network according to the preferred embodiment of the present invention. Herein, when the asynchronous mobile communication system 200 is connected to the MM-MB terminal 100 for a packet call, a service redirection method to a synchronous mobile communication system 300 is explained.

If the asynchronous mobile communication system 200 is connected to the MM-MB terminal 100 for a packet call, the EMS 260 monitors whether there is an error in the asynchronous mobile communication system 200 [S401].

The EMS 260 requests the asynchronous mobile communication system 200 to broadcast a service redirection request message to all of the MM-MB terminals 100 set for a packet call in the asynchronous mobile communication system 200 [S402].

Subsequently, the asynchronous mobile communication system 200 transmits the call redirection message including the information of the BTS 310 to be redirected to the MM-MB terminal 100 [S403]. Preferably, the asynchronous modem 123 of the MM-MB terminal 100 receives the message. At this time, the service redirection message includes a frequency information and a PN code information which are required for the MM-MB terminal 100 to redirect a packet call to the synchronous mobile communication system 300.

Subsequently, if the MM-MB terminal 100 receives the service redirection message from the asynchronous mobile communication system 200, the asynchronous modem 123 requests the synchronous modem 133 to redirect the mode to an idle state so that a service redirection can be performed from the asynchronous mobile communication system 200 to a synchronous mobile communication system 300 [S404]. According to the request by the asynchronous modem 123, the synchronous modem 133 transits its low power mode to an idle state. Thereafter, a synchronicity is adjusted to correspond between the BTS 310 of the synchronous mobile communication system 300 and a pilot channel.

Subsequently, the MM-MB terminal 100 retransmits a packet call to the synchronous mobile communication system 300 through the synchronous modem [S405]. According to this, the MM-MB terminal 100 and the synchronous mobile communication system 300 transmit and receive a packet data and maintain a packet call state.

It is understood by those skilled in the art that various changes or modifications may be made in the above embodiment of the present invention without departing from the spirit and scope of the invention. Thus, the scope of the present invention will be represented by the claims to follow, and all the modifications and changes from the claims and their equivalents will be interpreted to be included within the present invention.

### INDUSTRIAL APPLICABILITY

The present invention relates to a mobile communication service system and a method thereof for service redirection between an asynchronous network and a synchronous network, which performs a service redirection from an asynchronous network based mobile communication system to a synchronous network based mobile communication system.

1. A mobile communication service system for redirecting services between an asynchronous network and a synchronous network comprising:
an asynchronous network based mobile communication service system;
a synchronous network based mobile communication service system; and
a mobile terminal wireless-connection to the asynchronous network based mobile communication service system and the synchronous network based mobile communication service system and being provided with a service adequate to the quality and environment of each network, wherein the asynchronous network based mobile communication service system includes an EMS (Element Management System) monitoring the asynchronous network based mobile communication service system and, if an error occurs in the system, broadcasting a network redirection message, which requests for the redirection of services to the synchronous network based mobile communication service system, to all of the mobile terminals, which are being connected to and served by the asynchronous network based mobile communication service system, through the asynchronous network based mobile communication service system.

2. The mobile communication service system for redirecting services between an asynchronous network and a synchronous network as claimed in claim 1, wherein if the service is a voice based call service, the asynchronous network based mobile communication service system broadcasts to the mobile terminal a message requesting a handover of the service to the synchronous network based mobile communication service system.

3. The mobile communication service system for redirecting services between an asynchronous network and a synchronous network as claimed in claim 1, wherein if the service is a data packet service, the asynchronous network based mobile communication service system broadcasts to the mobile terminal a message requesting a service redirection to the synchronous network based mobile communication service system.

4. The mobile communication service system for redirecting services between an asynchronous network and a synchronous network as claimed in claim 3, wherein the service redirection message includes a frequency information and a PN code information which are required for the mobile terminal to redirect the service to the synchronous network based mobile communication service system.

5. The mobile communication service system for redirecting services between an asynchronous network and a synchronous network as claimed in claim 1, wherein the mobile terminal includes a synchronous modem for receiving a synchronous network based mobile communication service and an asynchronous modem for receiving an asynchronous network based mobile communication service, and the mobile terminal is a multi-mode multi-band terminal processing a plurality of frequency bands.

6. A mobile communication service method for redirecting services between an asynchronous network and a synchronous network comprising the steps that: (a) if an error occurs in an asynchronous network based mobile communication service system, an element management system requests all of the multi-mode multi-band terminals (hereinafter, MM-MB terminals), which receive services from the asynchronous network based mobile communication service system, to redirect their modes to the synchronous network based mobile communication service system; and (b) the MM-MB terminals perform a network redirection from the asynchronous network based mobile communication service system to the synchronous network based mobile communication service system.

7. The mobile communication service method for redirecting services between an asynchronous network and a synchronous network as claimed in claim 6, wherein the step (b) includes the steps that: (b1) an asynchronous modem receives a handover request from the asynchronous network based mobile communication service system; (b2) the asynchronous modem performs a traffic transit to a synchronous modem; and (b3) the synchronous modem acquires a synchronicity from the synchronous network based mobile communication system and transmits a message of informing the completion of the handover.

8. The mobile communication service method for redirecting services between an asynchronous network and a synchronous network as claimed in claim 6, wherein the step (b) includes the steps that: (b1) an asynchronous modem receives a service redirection message from the asynchronous network based mobile communication service system; (b2) the asynchronous modem requests the synchronous modem to redirect the mode to an idle state; (b3) the synchronous modem transits its low power mode to an idle state; and (b4) the synchronous modem retransmits a packet call to the synchronous network based mobile communication service system.

9. The mobile communication service method for redirecting services between an asynchronous network and a synchronous network as claimed in claim 8, wherein the service redirection message includes a frequency information and a PN code information which are required for the synchronous modem to retransmit the packet call.

10. The mobile communication service method for redirecting services between an asynchronous network and a synchronous network as claimed in claim 8, wherein the step (b3) further includes a step that the synchronous modem acquires a pilot channel and synchronicity from the synchronous network based mobile communication service system.

11. The mobile communication service system for redirecting services between an asynchronous network and a synchronous network as claimed in claim 2, wherein the mobile terminal includes a synchronous modem for receiving a synchronous network based mobile communication service and an asynchronous modem for receiving an asynchronous network based mobile communication service, and the mobile terminal is a multi-mode multi-band terminal processing a plurality of frequency bands.

12. The mobile communication service system for redirecting services between an asynchronous network and a synchronous network as claimed in claim 3, wherein the mobile terminal includes a synchronous modem for receiving a synchronous network based mobile communication service and an asynchronous modem for receiving an asynchronous network based mobile communication service, and the mobile terminal is a multi-mode multi-band terminal processing a plurality of frequency bands.

13. The mobile communication service system for redirecting services between an asynchronous network and a synchronous network as claimed in claim 4, wherein the mobile terminal includes a synchronous modem for receiving a synchronous network based mobile communication service and an asynchronous modem for receiving an asynchronous network based mobile communication service, and the mobile terminal is a multi-mode multi-band terminal processing a plurality of frequency bands.
